(19) United States
(12) Patent Application Publication
(10) Pub. No.: US 2010/0163257 A1
(43) Pub. Date: Jul. 1, 2010

(54) SEEDLING HARVESTING APPARATUS

(75) Inventor: BRUCE G. FRANCIS, AIKEN, SC (US)

Correspondence Address: WEYERHAEUSER COMPANY;INTELLECTUAL PROPERTY DEPT., CH 1J27, P.O. BOX 9777, FEDERAL WAY, WA, 98063, US

(73) Assignee: WEYERHAEUSER COMPANY, FEDERAL WAY, WA (US)

(21) Appl. No.: 12/347,149

(22) Filed: Dec. 31, 2008

(51) Int. Cl. A01D 25/00; A01D 25/04; A01D 31/00; A01D 33/00

(52) U.S. Cl. 171/111

(57) ABSTRACT

A harvester (20) is provided. The harvester includes a frame (22) having selectively positionable wheels, a plant transport apparatus (24) disposed on the frame, and a seedling conveyor (26) positioned adjacent the plant transport apparatus and positioned to transfer seedlings along a conveyor axis that extends between the plant transport apparatus and a storage bin. The harvester also includes a root soil remover (28) positioned adjacent the seedling conveyor. The root soil remover includes a plurality of flexible probes selectively positioned during operation of the harvester such that at least one of the plurality of flexible probes is in functional contact with a root end of a seedling being transported by the seedling conveyor, wherein motion of the root soil remover is initiated by at least a portion of the seedling passing through the plurality of flexible probes.

### BACKGROUND

Seedlings are sown in a nursery bed in paired rows for efficiency. Currently available harvesters used to sow such seedlings typically include a lifter blade that is drawn under the seedlings to sever deep roots and to loosen the soil surrounding the roots of the seedling. One such harvester is disclosed in U.S. Pat. No. 4,326,590, entitled Plant-Harvesting Device for Use with Variable Crop Row Spacing, assigned to Weyerhaeuser Company, assignee of the present disclosure (“the '590 patent”). As set forth in the '590 patent, existing harvesters include a root-untangling and soil removal apparatus 28. Such root-untangling and soil removal apparatuses 28 include a plurality of stiff arms 52 mounted on shafts 54 that are driven by drive mechanism contained in a housing 50. The drive mechanism is driven by a motor 88 through a chain 81. In operation, the root ends of seedlings 90 are gently impacted by the rotating arms 52 to remove residual soil.

Although such harvesters are effective at retrieving seedlings from nursery beds, they are not without their problems. As a non-limiting example, the arms 52 of the root- untangling and soil removal apparatus 28 are constructed from a stiff material that damages the root tips during use. This results in a reduced yield of productive seedlings that will survive transplant from the nursery.

Another problem with existing harvesters relates to the root-untangling and soil removal apparatuses 28 being driven. As noted above, the root-untangling and soil removal apparatus 28 is driven by a motor 88 during operation. It has been discovered by the inventors of the present disclosure that driven root-untangling and soil removal apparatuses creates drag on the root tips of seedling being processed by the harvester. Such drag is undesirable as the drag created by the driven root-untangling and soil removal apparatus damages the root tips and, therefore, reduces the long term survival rate of seedlings.

As such, there exists a need for a harvester that includes a root soil removal apparatus that removes residual soil from the roots of seedlings while minimizes damage to the roots of such seedlings.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A harvester constructed in accordance with one embodiment of the present disclosure is provided. The harvester includes a frame having selectively positionable wheels, a plant transport apparatus disposed on the frame and a seedling conveyor positioned adjacent the plant transport apparatus. The seedling conveyor is positioned to transfer seedlings along a conveyor axis that extends between the plant transport apparatus and a storage bin. The harvester also includes a root soil remover positioned adjacent the seedling conveyor. The root soil remover includes a plurality of flexible probes selectively positioned during operation of the harvester such that at least one of the plurality of flexible probes is in functional contact with a root end of a seedling being transported by the seedling conveyor.

A harvester constructed in accordance with a second embodiment of the present disclosure includes a frame having selectively positionable wheels, a seedling conveyor and a conveyor. The conveyor is disposed on the frame and positioned relative to the seedling conveyor to support a root portion of a seedling while a stem portion of the seedling is disposed within the seedling conveyor. The seedling conveyor and the conveyor move the seedling within the frame along a conveyor axis. The harvester also includes a first root soil remover positioned adjacent the second conveyor. The first root soil remover includes a plurality of flexible probes extending radially from a hub and selectively positioned during operation of the harvester such that at least one of the plurality of flexible probes is in functional contact with the root end of the seedling being transported by the conveyor.

A harvester constructed in accordance with another embodiment of the present disclosure includes a frame having selectively positionable wheels, a plant transport apparatus disposed on the frame and a seedling conveyor positioned adjacent the plant transport apparatus. The seedling conveyor is positioned to transfer seedlings along a conveyor axis that extends between the first plant transport apparatus and a storage bin. A first root soil remover is positioned adjacent the seedling conveyor and has a plurality of flexible probes extending radially from a hub. The plurality of flexible probes are selectively positioned during operation of the harvester such that at least one of the plurality of flexible probes is in functional contact with a root end of a seedling being transported by the seedling conveyor. The harvester also includes a second root soil remover positioned adjacent the first root soil remover to remove soil from the root portion of the seedling after the seedling exits the first root soil remover.

A harvester constructed in accordance with the above embodiments has several advantages over those currently available in the art. As a non-limiting example, the root soil remover of the above harvester minimizes drag on the seedling and, therefore, minimizes root damage during soil removal. This results in an approximately 44%-70% improvement in root tip retention while compared to existing harvesters. The mean is 40% -63% and is dependent on the operating speed of the harvester. As a result, the harvester of the present disclosure represents a significant improvement over currently available harvesters.

### DESCRIPTION OF THE DRAWINGS

The foregoing aspects and many of the attendant advantages of this invention will become better understood by reference to the following detailed description, when taken in conjunction with the accompanying drawings, wherein:

FIG. 1 is an isometric view of a harvester constructed in accordance with one embodiment of the present invention;

FIG. 2 is an isometric view of the harvester of FIG. 1 with a portion of the frame removed for clarity;

FIG. 3 is a partial isometric view of a root soil remover constructed in accordance with aspects of the present disclosure; and

FIG. 4 is a side planar view of the harvester of FIG. 1 in use and showing root portions of plants supported by a portion of the harvester.

### DETAILED DESCRIPTION

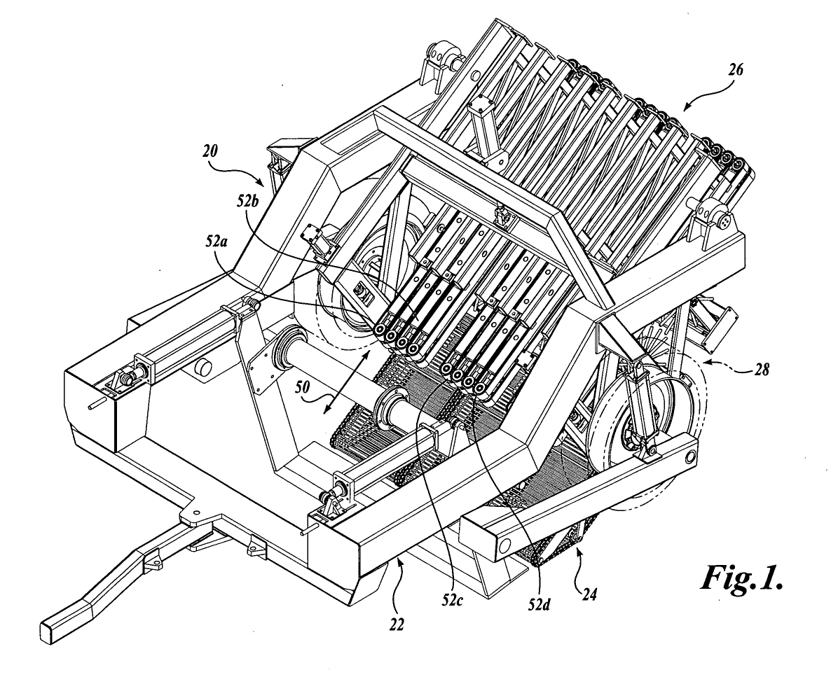

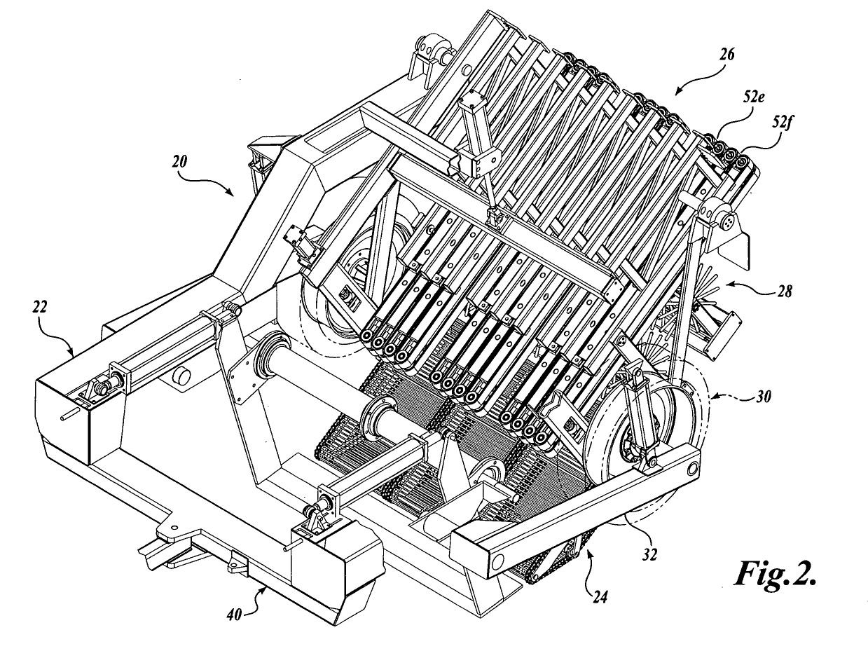

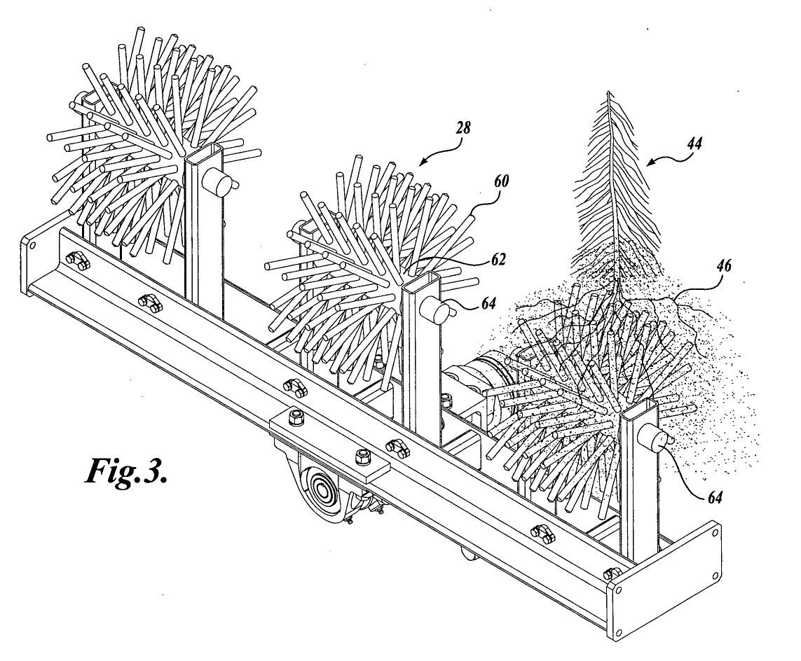

A harvester 20 constructed in accordance with embodiments of the present disclosure may be best understood by referring to FIGS. 1-3. The harvester 20 includes a frame 22, a plant transport apparatus 24, a plurality of seedling conveyors 26, and a root soil remover 28. The frame 22 is a well-known type of frame currently used in the art and is manufactured from a high strength material, such as steel. The frame 22 includes positionable wheels 30 (shown in phantom) mounted on a moveable wheel frame 32. The wheel frame 32 is mounted for selective reciprocation between a stowed position (shown in FIGS. 2 and 3) and an extended position. In the extended position the wheels 30 are displaced into a downward position for moving the harvester 20 between locations. The wheels 30 are displaced in an upward position for seeding lifting and the position of the wheels 30 may be varied to adjust the blade depth required for lifting seedlings from the nursery bed.

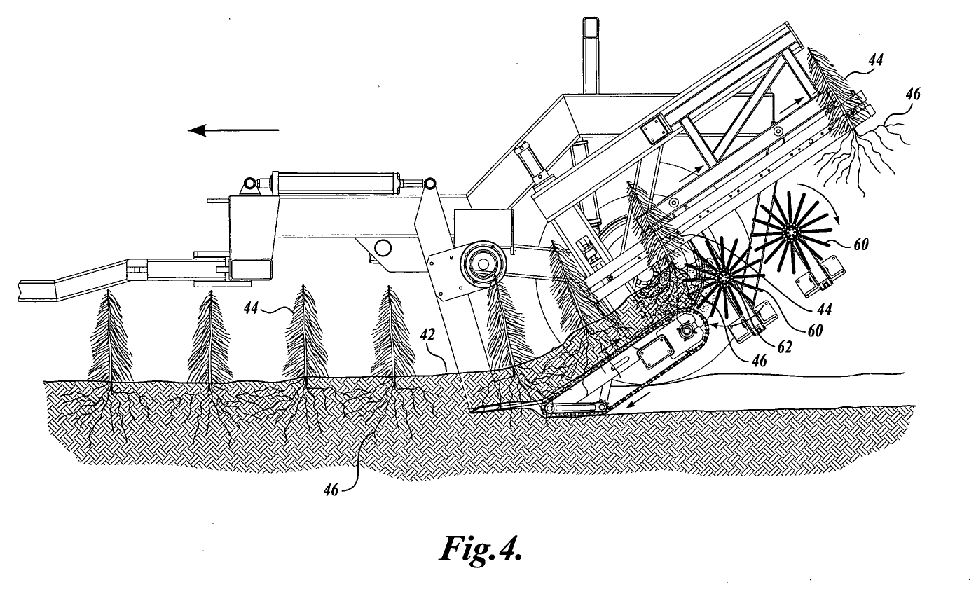

The frame 22 also includes a horizontal undercutting blade 40 which serves to sever an intact body of soil 42 (FIG. 4) containing seedlings 44 and their root structure 46. The width of the undercutting blade 40 is suitably sized to support the soil 42 of the seedling bed to minimize damage to the root structure 46 as the seedlings 44 are lifted from within the nursery field and transferred to the plant transport apparatus 24.

The plant transport apparatus 24 is suitably a smooth surface conveyor having a plurality of horizontal openings. One such plant transport apparatus 24 is suitably manufactured from a rod chain or slated belt driven by a hydraulic motor (not shown) acting through a drive chain on a sprocket. The spacing between the rods or slats allow soil to pass through while supporting the seedling bed 42. Supporting the seedling bed 42 during harvesting minimizes the risk of the seedling bed 42 from flexing and, thereby, damaging the roots 46 of seedlings 44 being harvested.

The plant transport apparatus 24 is suitably synchronized in a manner well-known in the art to the forward speed of the harvester 20 to minimize drag against the root portion 46 of the seedlings 44. During operation, it is preferable that the front end of the plant transport apparatus 24 be disposed between eight and 10 inches below the surface of the seedling bed 42. It is also desirable that the leading edge of the plant transport apparatus 24 be positioned beneath the trailing edge of the blade 40 to facilitate smooth lifting and transfer of the cut seedling bed 42 from the blade 40 to the plant transport apparatus 24. As configured, the seedling bed 24 is continuously supported from the point it is removed from the nursery bed until entry into the root soil remover 28. This is done to minimize root tip breakage and stem damage resulting from the downward pull on the seedlings 44 caused by the soil weight within the root systems 46.

As may be best seen by referring to FIGS. 1 and 2, the seedling conveyor 26 is suitably located adjacent the plant transport apparatus 24 and is positioned to transfer seedlings 44 along a conveyor axis (shown by the arrow 50) that extends between the plant transport apparatus 24 and a stowage bin (not shown). The seedling conveyor 26 includes a match set of timing belts 52a-52f. Each of the timing belts 52a-52f hold seedlings 44 in an upright orientation from a position before the seedling bed 42 exits the plant transport apparatus 24 to a point where the seedlings 44 enter the stowage bin.

The seedling conveyor 26 is mounted on the frame 22 and create two points of contact on opposite sides of the seedlings 44 as they pass through the harvester 20. It is preferred to match the timing of movement of both the plant transport apparatus 24 and seedling conveyor 26 to minimize drag damage to seedling 44 being processed by the harvester 20.

As may be best seen by referring to FIG. 3, the root soil remover 28 includes a plurality of flexible probes 60 mounted on a hub 62 and axle 64 to permit free rotation of the plurality of flexible probes 60 during use and as detailed below. The flexible probes 60 are suitably formed from a sprocket chain coated with a cushioning material, such as polyurethane or polyethylene, to minimize damage caused by the impact of the probes against the roots 46 of the seedling 44. Further, the flexible probes 60 are permitted to flex along the direction of the conveyor axis 50 but they are substantially stiffened to minimize flexure in a direction substantially normal to the conveyor axis 50.

As noted, the root soil conveyors 28 are mounted for free rotation on the axle 64 such that motion of the root soil remover 28 is initiated by at least a portion of the seedling 44 passing through the plurality of flexible probes 60. As a non-limiting example, as the seedling 44 is transported in the harvester 20 by the seedling conveyor 26, the root portion 46 contacts the plurality of flexible probes 60 to cause the rotation of the root soil remover 28 on the axle 64. Note that the root soil removers 28 are not driven in the direction of seedling travel by any mechanical means, such as a drive motor. As such, the free rotating nature of the root soil conveyor 28 minimizes drag on the seedling 44 and root tip 46 during use. This is advantageous as reduced drag reduces damage to the roots 46.

Operation of the harvester 20 may be best understood by referring to FIGS. 3 and 4. Seedlings 44 are shown growing in the ground in advance of the harvester 20. Seedlings 44 are picked up including a body of soil 42 which has been severed by the blade 40. The soil body 42 including seedlings 44 are lifted onto the plant transport apparatus 24 by the forward motion of the harvester 20. The soil 42 and seedlings 44 are conveyed along the plant transport apparatus 24 to a point where the stem portion of the seedling 44 is engaged by the paired belts 52 of the seedling conveyor 26.

As the seedlings 44 are propelled within the paired belts 52 of the seedling conveyor 26, they exit the end of the plant transport apparatus 24 where they gently engage the root soil remover 28. Specifically, the root portions 46 of the seedlings 44 engage the plurality of flexible probes 60 of the root soil remover 28, whereby the motion of the seedling 44 relative to the root soil remover 28 causes the rotation of the root soil remover 28. Each probe of the plurality of flexible probe 60 is capable of flexing in the direction of seedling flow (shown by the conveyor axis 50) to remove soil and to minimize damage to root tips. While the probes are permitted to flex in the direction of the conveyor axis 50, they are rigid is a direction substantially perpendicular to seedling flow so that the soft probes do not spread open relative to each other. As such, they remain within the root structure 46 of the seedling 44 passing through the root soil remover 28.

In certain embodiments, a plurality of root soil removers 28 may be aligned in series to subject the root portions 46 to subsequent soil removal processing. At the end of the paired belts 52, the seedlings 44 are discharged from the belt 52 into a storage bin for sorting, counting, and subsequent packaging.

While illustrative embodiments have been illustrated and described, it will be appreciated that various changes can be made therein without departing from the spirit and scope of the invention.

The embodiments of the invention in which an exclusive property or privilege is claimed are defined as follows:

1. A harvester, comprising:
(a) a frame having selectively positionable wheels;
(b) a plant transport apparatus disposed on the frame;
(c) a seedling conveyor positioned adjacent the plant transport apparatus and positioned to transfer seedlings along a conveyor axis that extends between the plant transport apparatus and a storage bin; and
(d) a root soil remover positioned adjacent the seedling conveyor, the root soil remover having a plurality of flexible probes selectively positioned during operation of the harvester such that at least one of the plurality of flexible probes is in functional contact with a root end of a seedling being transported by the seedling conveyor, wherein motion of the root soil remover is initiated by at least a portion of the seedling passing through the plurality of flexible probes.

2. The harvester of claim 1, wherein the plurality of flexible probes are constructed to be flexible substantially along an axis that is parallel to the conveyor axis.

3. The harvester of claim 2, wherein each of the plurality of flexible probes include a chain coated with a cushioning material.

4. The harvester of claim 2, further comprising a blade disposed in front of and overlapping a portion of the plant transport apparatus.

5. The harvester of claim 4, wherein the plant transport apparatus is a continuous conveyor.

6. The harvester of claim 5, wherein the plant transport apparatus supports the root portion of the plant until it reaches the root cleaner.

7. A harvester, comprising:
(a) a frame having selectively positionable wheels;
(b) a seedling conveyor disposed on the frame;
(c) a conveyor disposed on the frame and positioned relative to the seedling conveyor to support a root portion of a seedling while a stem portion of the seedling is disposed within the seedling conveyor, wherein the seedling conveyor and the conveyor move the seedling within the frame along a conveyor axis; and
(d) a first root soil remover positioned adjacent the conveyor, the first root soil remover having a plurality of flexible probes extending radially from a hub and selectively positioned during operation of the harvester such that at least one of the plurality of flexible probes is in functional contact with the root end of the seedling being transported by the second conveyor, wherein motion of the first root soil remover is initiated by at least a portion of the seedling passing through the plurality of flexible probes.

8. The harvester of claim 7, further comprising a second root soil remover positioned adjacent the first root soil remover.

9. The harvester of claim 8, wherein the second root soil remover includes a second plurality of flexible probes extending radially from a second hub.

10. The harvester of claim 9, wherein each probe of the first and second plurality of probes is capable of flexing in substantially in a first direction that is parallel to the conveyor axis.

11. The harvester of claim 10, wherein each probe of the first and second plurality of probes is substantially inflexible along an axis perpendicular to the conveyor axis.

12. The harvester of claim 9, wherein each probe of the first and second plurality of probes includes a chain coated with a cushioning material.

13. A harvester, comprising:
(a) a frame having selectively positionable wheels;
(b) a plant transport apparatus disposed on the frame;
(c) a seedling conveyor positioned adjacent the plant transport apparatus and positioned to transfer seedlings along a conveyor axis that extends between the first plant transport apparatus and a storage bin;
(d) a first root soil remover positioned adjacent the seedling conveyor, the first root soil remover having a plurality of flexible probes extending radially from a hub and selectively positioned during operation of the harvester such that at least one of the plurality of flexible probes is in functional contact with a root end of a seedling being transported by the seedling conveyor, wherein motion of the first root soil remover is initiated by at least a portion of the seedling passing through the plurality of flexible probes; and
(e) a second root soil remover positioned adjacent the first root soil remover to remove soil from the root portion of the seedling after the seedling exits the first root soil remover.

14. The harvester of claim 13, wherein the second root soil remover includes a second plurality of flexible probes extending radially from a second hub.

15. The harvester of claim 14, wherein each probe of the first and second plurality of probes is capable of flexing in substantially in a first direction that is parallel to the conveyor axis.

16. The harvester of claim 15, wherein each probe of the first and second plurality of probes is substantially inflexible along an axis perpendicular to the conveyor axis.

17. The harvester of claim 14, wherein each probe of the first and second plurality of probes includes a chain coated with a cushioning material.
